(19) United States
(12) Patent Application Publication
(10) Pub. No.: US 2025/0356459 A1
(43) Pub. Date: Nov. 20, 2025

(54) IMAGING DEVICE AND IMAGE PROCESSING METHOD FOR THE SAME

(71) Applicant: SK hynix Inc., Icheon-si (KR)

(72) Inventor: Eun Khwang LEE, Icheon-si (KR)

(21) Appl. No.: 19/009,769

(22) Filed: Jan. 3, 2025

(30) Foreign Application Priority Data
May 14, 2024 (KR) 10-2024-0063452

(51) Int. Cl. G06T 5/10; G06T 3/60; G06T 7/00; G06T 7/11

(52) U.S. Cl. CPC G06T 5/10; G06T 3/60; G06T 7/0002; G06T 7/11; G06T 2207/20021; G06T 2207/20056

(57) ABSTRACT

An imaging device and an image processing method and an image testing method for the same are disclosed. The image processing method includes generating a first transformed image by performing Fourier transform on a raw image; generating a second transformed image obtained by correcting the first transformed image using a correction parameter; and generating a corrected image by performing inverse Fourier transform on the second transformed image.

### CROSS-REFERENCE TO RELATED APPLICATION

This patent document claims the priority and benefits of Korean patent application No. 10-2024-0063452, filed on May 14, 2024, the disclosure of which is incorporated herein by reference in its entirety as part of the disclosure of this patent document.

### TECHNICAL FIELD

The technology and embodiments disclosed in this patent document generally relate to an imaging device, and more particularly to an imaging device capable of generating a corrected image using the Fourier transform method.

### BACKGROUND

Imaging devices are devices that capture images using the properties of semiconductors that respond light and generate final images through an image processing procedure that corrects the captured images. With the development of automotive, medical, computer and communication industries, the demand for high-performance image sensing devices is increasing in various devices such as smart phones, digital cameras, game machines, IoT (Internet of Things), robots, security cameras and medical micro cameras.

Imaging devices may include image sensing devices such as charge coupled device (CCD) image sensing devices and complementary metal oxide semiconductor (CMOS) image sensing devices. The CCD image sensing devices offer a better image quality, but they tend to consume more power and are larger as compared to the CMOS image sensing devices. The CMOS image sensing devices are smaller in size and consume less power than the CCD image sensing devices. Furthermore, CMOS image sensing devices are fabricated using the CMOS fabrication technology, and thus photosensitive elements and other signal processing circuitry can be integrated into a single chip, enabling the production of miniaturized imaging devices at a lower cost.

### SUMMARY

Various embodiments of the disclosed technology relate to an imaging device that can correct regular image defects caused by defects that may exist in a semiconductor wafer on which an image sensing device is implemented.

In an embodiment of the disclosed technology, an image processing method may include: generating a first transformed image by performing Fourier transform on a raw image; generating a second transformed image obtained by correcting an image effect present in the first transformed image using a correction parameter; and generating a corrected image by performing inverse Fourier transform on the second transformed image.

In some implementations, the correction parameter may include: a transformed dark image obtained by performing Fourier transform on a raw dark image generated in a dark condition (e.g., in low light or complete darkness).

In some implementations, the second transformed image may be a result of calculating a difference between the first transformed image and the transformed dark image.

In some implementations, the correction parameter may include at least one of a correction angle and a correction amplitude.

In some implementations, the correction amplitude may be the largest amplitude from among amplitudes of coordinates contained in a dark Fourier pattern included in a transformed dark image generated by performing Fourier transform on a raw dark image generated in a dark condition (e.g., in low light or complete darkness).

In some implementations, the correction angle may be an angle of rotation at which a dark Fourier pattern included in a transformed dark image generated by performing Fourier transform on a raw dark image generated in a dark condition (e.g., in low light or complete darkness) is rotated clockwise from any one of a horizontal axis and a vertical axis by which the transformed dark image is divided into first, second, third, and fourth quadrants.

In some implementations, the first transformed image may include a Fourier pattern that is a set of points located along a straight line rotated clockwise from the horizontal axis or the vertical axis by the correction angle. The second transformed image may be an image in which wave amplitudes of coordinates of the first transformed image contained in a quadrant including the dark Fourier pattern are respectively replaced with wave amplitudes of other coordinates symmetrical to any one of the horizontal axis and the vertical axis.

In some implementations, the first transformed image may include a Fourier pattern that is a set of points located along a straight line rotated clockwise from a horizontal axis or a vertical axis by the correction angle. The second transformed image may be an image in which the amplitude of each of coordinates on the Fourier pattern is set to zero.

In another embodiment of the disclosed technology, an imaging device may include: a Fourier transform operation unit configured to generate a first transformed image by performing Fourier transform on a raw image; a Fourier transform image correction unit configured to generate a second transformed image obtained by correcting the first transformed image using a correction parameter corresponding to the first transformed image; and an inverse Fourier transform operation unit configured to generate a corrected image by performing inverse Fourier transform on the second transformed image.

In some implementations, the correction parameter may include: a transformed dark image obtained by performing Fourier transform on a raw dark image generated in a dark condition (e.g., in low light or complete darkness).

In some implementations, the imaging device may further include: a memory device configured to store a transformed dark image obtained by performing Fourier transform on a raw dark image generated in a dark condition.

In some implementations, the second transformed image may be obtained by calculating a difference between the first transformed image and a transformed dark image obtained by performing Fourier transform on a raw dark image generated in a dark condition.

In some implementations, the correction parameter may include at least one of a correction angle and a correction amplitude.

In some implementations, the imaging device may further include: a memory device configured to store the correction parameter.

In some implementations, the correction amplitude may be the largest amplitude from among amplitudes of coordinates contained in a dark Fourier pattern included in a transformed dark image generated by performing Fourier transform on a raw dark image generated in a dark condition (e.g., in low light or complete darkness).

In some implementations, the correction angle may be an angle of rotation at which a dark Fourier pattern included in a transformed dark image generated by performing Fourier transform on a raw dark image generated in a dark condition (e.g., in low light or complete darkness) is rotated clockwise from any one of a horizontal axis and a vertical axis by which the transformed dark image is divided into first, second, third, and fourth quadrants.

In some implementations, the first transformed image may include a Fourier pattern that is a set of points located along a straight line rotated clockwise from the horizontal axis or the vertical axis by the correction angle. The second transformed image may be an image in which wave amplitudes of coordinates of the first transformed image contained in a quadrant including the dark Fourier pattern are respectively replaced with wave amplitudes of other coordinates symmetrical to any one of the horizontal axis and the vertical axis.

In some implementations, the first transformed image may include a Fourier pattern that is a set of points located along a straight line rotated clockwise from the horizontal axis or the vertical axis by the correction angle. The second transformed image may be an image in which the amplitude of each of coordinates on the Fourier pattern is set to zero.

In another embodiment of the disclosed technology, an image testing method may include: outputting a raw dark image from an image sensing device in a dark condition (e.g., in low light or complete darkness); generating a transformed dark image by performing Fourier transform on the raw dark image; dividing the transformed dark image into first to fourth quadrants, and comparing an average amplitude value or a median amplitude value of amplitude values of coordinates of the first to fourth quadrants with a maximum amplitude value from among the amplitude values of the coordinates of the first to fourth quadrants; and determining a correction angle and a correction amplitude of a dark Fourier pattern contained in the transformed dark image according to a result of the comparison.

In some implementations, the dark Fourier pattern may be a set of one or more points located along a straight line, and the correction angle may be an angle of rotation at which the straight line is rotated clockwise from any one of a horizontal axis and a vertical axis by which the transformed dark image is divided into first, second, third, and fourth quadrants.

In some implementations, the correction amplitude may be a maximum amplitude value from among amplitudes of points contained in the dark Fourier pattern.

In some implementations, the image testing method may further comprise: when comparing the maximum amplitude value from among the amplitude values of the coordinates of each of the first to fourth quadrants with the average amplitude value of the amplitude values of the coordinates of the first to fourth quadrants, in response to a determination that the maximum amplitude value is 900 times the average amplitude value or more, determining that the dark Fourier pattern is present.

It is to be understood that both the foregoing general description and the following detailed description of the disclosed technology are illustrative and explanatory and are intended to provide further explanation of the disclosure as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging device based on some implementations of the disclosed technology.

FIG. 2 is a block diagram illustrating an example of an image test device shown in FIG. 1 based on some implementations of the disclosed technology.

FIG. 3 is a flowchart illustrating an example method of calculating correction parameters by using the image test device shown in FIG. 2 based on some implementations of the disclosed technology.

FIG. 4 is a diagram illustrating an example result of Fourier transform raw dark image performed by the image test device shown in FIG. 2 on a raw dark image with regular image defects, based on some implementations of the disclosed technology.

FIG. 5 is a block diagram illustrating an example of an image processing device that can be included in the imaging device shown in FIG. 1 based on some implementations of the disclosed technology.

FIG. 6 is a flowchart illustrating an example method of performing an image correction process by using the image processing device shown in FIG. based on some implementations of the disclosed technology.

FIG. 7 is a diagram illustrating an example of a method for correcting a raw image having regular image defects using the Fourier transform by the image processing device shown in FIG. 5 based on some implementations of the disclosed technology.

### DETAILED DESCRIPTION

This patent document provides embodiments and examples of an imaging device that is designed to generate a corrected image using the Fourier transform method that may be used in configurations to substantially address one or more technical or engineering issues and to mitigate limitations or disadvantages encountered in some imaging devices in the art. The disclosed technology can be implemented in some embodiments to provide an imaging device that is designed to correct regular image defects caused by defects that may exist in a semiconductor wafer on which an image sensing device is implemented. To address issues related to regular image defects, the disclosed technology can be implemented in some embodiments to provide an imaging device that can generate a corrected image by removing or reducing regular image defects using the Fourier transform method.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

In some embodiments of the disclosed technology, terms such as first, second, etc., may be only used to distinguish one component from another, and do not limit the arrangement order and priority of the components.

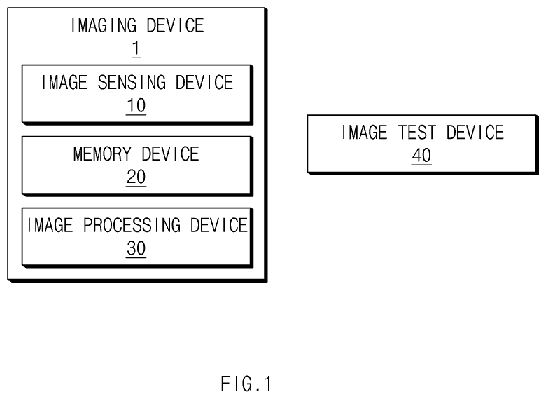

Embodiments of the disclosed technology will hereinafter be described in detail with reference to FIGS. 1 to 6.

FIG. 1 is a block diagram illustrating an example of an imaging device 1 based on some implementations of the disclosed technology.

Referring to FIG. 1, the imaging device 1 may include an image sensing device 10, a memory device 20, and an image processing device 30. The imaging device 1 may perform a photographing function for acquiring an image of a scene, and may be installed in electronic devices such as a camera, a mobile phone, and the like.

The image sensing device 10 may include a pixel array that generates an electrical signal upon receiving incident light from the outside, and a logic circuit that generates an image using the electrical signal. The logic circuit may include a correlated double sampler (CDS) configured to sample a signal level of the electrical signal in a pixel array, a converter configured to convert the signal received from the CDS into a digital signal, an output buffer configured to output the digital signal, and the like. In the image sensing device 10, an electrical signal output from the pixel array may pass through the logic circuit, resulting in formation of a raw image.

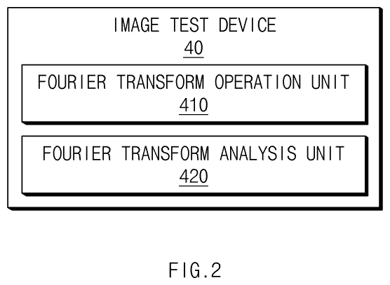

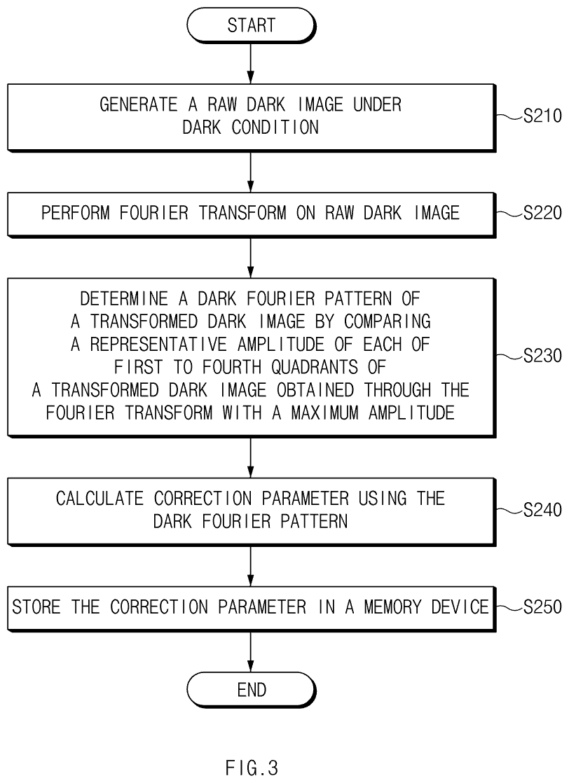

The memory device 20 may be a memory device that stores data. The memory device 20 may store correction parameters to be used for performing image correction that corrects certain image effect in a processed image such as reducing noise in the final image. The memory device 20 may be implemented as a non-volatile memory. For example, the memory device 20 may include various non-volatile memory devices such as a read only memory (ROM), a one-time programmable (OTP) memory, an erasable and programmable ROM (EPROM) memory, a NAND flash memory, a NOR flash memory, and the like. The memory device 20 may be provided inside the image sensing device 10 or may be installed separately from the image sensing device 10. FIG. 1 illustrates an embodiment in which the memory device 20 is separated from the image sensing device 10. Correction parameters that can be stored in the memory device 20 will be described with reference to FIGS. 2 and 3.

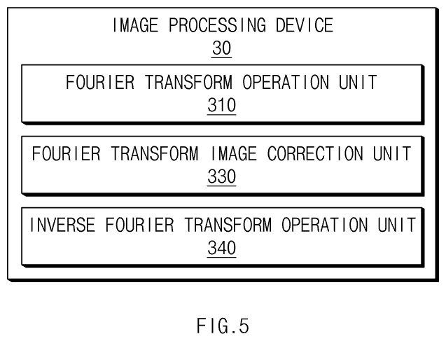

The image processing device 30 may create a corrected image by correcting the raw image generated by the image sensing device 10. When defects occur in a process of manufacturing the image sensing device 10, the raw image generated by the image sensing device 10 may have a regular defect pattern. The regular defect pattern may be a default pattern that may appear in the raw image depending on defects occurred in the process of manufacturing the image sensing device 10. The regular defect pattern may be a defect pattern that may appear regardless of the amount of light incident upon the image sensing device 10. The image processing device 30 may generate a corrected image from which the regular defect pattern has been removed using correction parameters stored in the memory device 20 to remove the regular defect pattern. In some implementations, the correction parameters may be parameters to be used for image correction using the Fourier transform. A method for generating the corrected image by the image processing device 30 will be described with reference to FIGS. 5 to 7.

The image test device 40 may be a device that determines correction parameters to be stored in the memory device 20. The image test device 40 may determine the presence or absence of a regular defect pattern using the raw image generated by the image sensing device 10. When the presence of the regular defect pattern in the raw image is determined, the image test device 40 may determine correction parameters required to remove the regular defect pattern. The correction parameters may be stored in the memory device 20. A method for determining the correction parameters by the image test device 40 will be described with reference to FIGS. 2 to 4.

FIG. 2 is a block diagram illustrating an example of the image test device 40 shown in FIG. 1 based on some implementations of the disclosed technology.

Referring to FIGS. 1 and 2, the image test device 40 may perform a test process on the imaging device 1 including, for example, the image sensing device 10, to determine whether a regular defect pattern exists in an image (e.g., a raw image) generated by the image sensing device 10. For example, the regular defect pattern may be a noise pattern in an image that shows defects or other issues with the image sensing device 10 that result from a manufacturing process of the image sensing device 10. When it is determined that the regular defect pattern exists in an image such as a raw image through the test process, the image test device 40 may determine correction parameters for removing the regular defect pattern. Correction parameters determined by the image test device 40 may be stored in advance in the memory device 20. In some embodiments, the term “correction parameter” can be used to indicate values associated with certain undesired effects including image defects such as regular defect patterns and image noise. As discussed below, the correction parameters can include the angle (e.g., “correction angle”) and intensity (e.g., “correction amplitude”) of the noise pattern.

The image test device 40 may determine whether at least one regular image defect exists in a raw dark image output by the image sensing device 10 in a dark condition (e.g., in low light or complete darkness). In some embodiments, the term “dark image” can be used to indicate an image that is generated in low light or complete darkness. The raw dark image that is generated in a dark condition (e.g., in low light or complete darkness) may be, for example, a raw image generated by the image sensing device 10 in a state in which light entering the image sensing device 10 is blocked. The image test device 40 may include a Fourier transform operation unit 410 and a Fourier transform analysis unit 420.

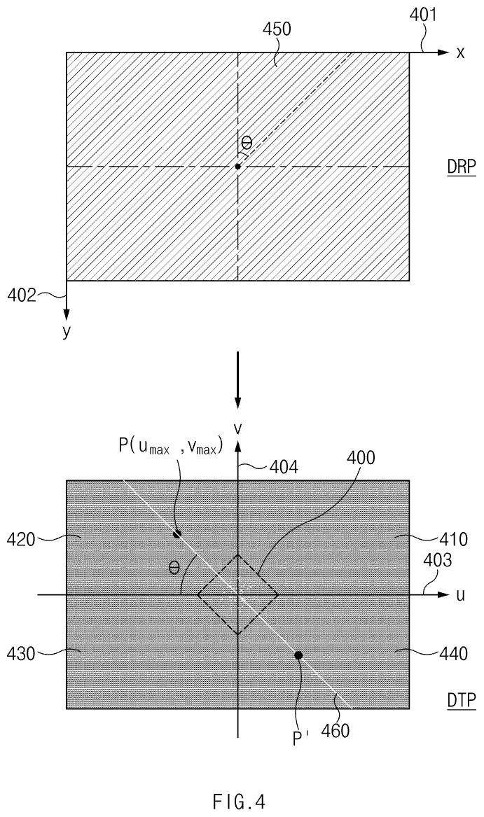

The Fourier transform operation unit 410 may generate a transformed dark image by performing Fourier transform on the raw dark image generated by the image sensing device 10 in a dark condition (e.g., in low light or complete darkness). The raw dark image may be, for example, an image with a specific resolution that is generated by the image sensing device 10 including a pixel array of size (W×H) (where “W” and “H” are each integers equal to or greater than 1). A transformed dark image obtained by Fourier transforming the raw dark image having the size of (W×H) may also be an image having the size of (W×H). The transformed dark image may be an origin-symmetric image that is symmetrical about the origin when the center of the transformed dark image is set to the origin due to characteristics of the Fourier transform. The characteristics of the Fourier transform will be described below with reference to FIG. 3. When the regular defect pattern exists in the raw dark image, the transformed dark image may include a dark Fourier pattern that includes one or more points in some regions except the center (e.g., a central portion 400 of FIG. 4) of the transformed dark image. The dark Fourier pattern may include at least some of the one or more points included in a region extending in a direction. In some implementations, the dark Fourier pattern may include a set of continuous dots extending in the direction. In some other implementations, the dark Fourier pattern may include a set of discontinuous points arranged in the direction. Further details about the raw dark image and the transformed dark image will be described with reference to FIG. 4.

The Fourier transform analysis unit 420 may determine whether the dark Fourier pattern appears. The transformed dark image may have a relatively large amplitude in a low-frequency region due to the Fourier transform characteristics to be described later, and may have a relatively small amplitude in a high-frequency region due to the Fourier transform characteristics. The low-frequency region may refer to a central portion of the transformed dark image. The greater the amplitude (or intensity) of specific coordinates in the transformed dark image, the brighter the coordinates may appear in the transformed dark image. In some embodiments, the term “amplitude” may refer to the amplitude of a wave function when the image is Fourier transformed and expressed as a plurality of wave functions.

When the regular defect pattern exists in the raw image, the regular defect pattern may include a wave function with a specific frequency. When the Fourier transform operation unit 410 performs Fourier transform on the wave function having the specific frequency, the wave function having the specific frequency may be expressed using coordinates having a specific amplitude corresponding to the amplitude of the wave function at a distance corresponding to the specific frequency from the origin (center) of the transformed dark image in response to the propagation direction of the wave function contained in the transformed dark image. The Fourier transform analysis unit 420 may determine the presence or absence of a dark Fourier pattern in the transformed dark image by considering the presence or absence of coordinates having a greater amplitude than a peripheral region in the transformed dark image. When the Fourier transform analysis unit 420 determines the dark Fourier pattern is present, the Fourier transform analysis unit 420 may determine a parameter that can express the characteristics of the dark Fourier pattern to be a correction parameter. Further details about the presence or absence of the dark Fourier pattern will be described later with reference to FIGS. 3 and 4.

FIG. 3 is a flowchart illustrating an example method of calculating correction parameters by using the image test device 40 shown in FIG. 2 based on some implementations of the disclosed technology.

FIG. 4 is a diagram illustrating an example result of Fourier transform performed by the image test device 40 shown in FIG. 2 on a raw dark image with regular image defects, based on some implementations of the disclosed technology.

FIG. 3 is a flowchart illustrating an example of a method for calculating correction parameters by the image test device 40 when the regular defect pattern exists in the raw dark image generated by the image sensing device in a dark condition (e.g., in low light or complete darkness).

Referring to FIGS. 2 to 4, the image sensing device 10 may generate a raw dark image (DRP) in a dark condition (e.g., in low light or complete darkness) (S210). For example, the term “dark condition” may be used to indicate a state in which light entering the image sensing device 10 is blocked. Hereinafter, an example case where the raw dark image (DRP) includes a regular defect pattern 450 will be described with reference to the attached drawings. The raw dark image (DRP) may have an X-axis coordinate value on an X-axis 401 that passes through the origin and extends horizontally, and may have a Y-axis coordinate value on a Y-axis 402 that passes through the origin and extends vertically. Here, each coordinate (x, y) included in the raw dark image (DRP) may have a pixel value. Since the image is a two-dimensional (2D) discrete signal and consists of signals defined within a resolution range of (W×H), the raw dark image (DRP) may be expressed as a function f (x, y). Here, “W” and “H” may be each integers equal to or greater than 1. In this case, “X” may be any one of integers ranging from 0 to W-1, and “Y” may be any one of integers ranging from 0 to H-1.

The Fourier transform operation unit 410 may perform Fourier transform on the raw dark image (DRP) (S220). When the Fourier transform operation unit 410 performs the Fourier transform using, for example, the following equation 1, a transformed dark image (DTP) can be generated (or created). The transformed dark image (DTP) of FIG. 4 exemplarily illustrates an image corresponding to log (|F (u-W/2, v-H/2)|).

$$F ( u , v ) = \frac{1}{WH} {\sum }_{x = 0}^{W - 1} {\sum }_{y = 0}^{H - 1} f ( x , y ) {e}^{- i 2 π ( u \frac{x}{W} + v \frac{y}{H} )} \qquad [ Equation 1 ]$$

As can be seen from Equation 1, |F (u, v)| is equal to |F (−u,−v)| (i.e., |F (u, v)|=|F (−u,−v)|), so that the transformed dark image (DTP) may appear as an origin-symmetric image.

The transformed dark image (DTP) may be expressed as a function F (u, v) as represented by Equation 1. The transformed dark image (DTP) may include a dark Fourier pattern 460. With respect to the u-axis 403 indicating a horizontal axis passing through the center of the transformed dark image (DTP) and the v-axis 404 indicating a vertical axis passing through the center of the transformed dark image (DTP), each of coordinates contained in the transformed dark image (DTP) may represent a proceeding direction of each wave function included in the raw dark image (DRP), a frequency of each wave function, and the amplitude (strength or intensity) of each wave function. For example, an example case for a specific point “P (uₘₐₓ, vₘₐₓ)” having the greatest amplitude will hereinafter be described in detail. When signals corresponding to the regular defect pattern 450 included in the raw dark image (DRP) are expressed as a sum of one or more wave functions, the point “P (uₘₐₓ, vₘₐₓ)” may be a coordinate value representing the wave function having the greatest amplitude. The angle θ at which the point P rotates clockwise from the u-axis 403 may refer to the direction in which the wave function progresses, and the distance from the origin to the point P may refer to the frequency of the wave function. The transformed dark image (DTP) may be divided into first to fourth quadrants (410, 420, 430, 440) by the u-axis 403 and the v-axis 404.

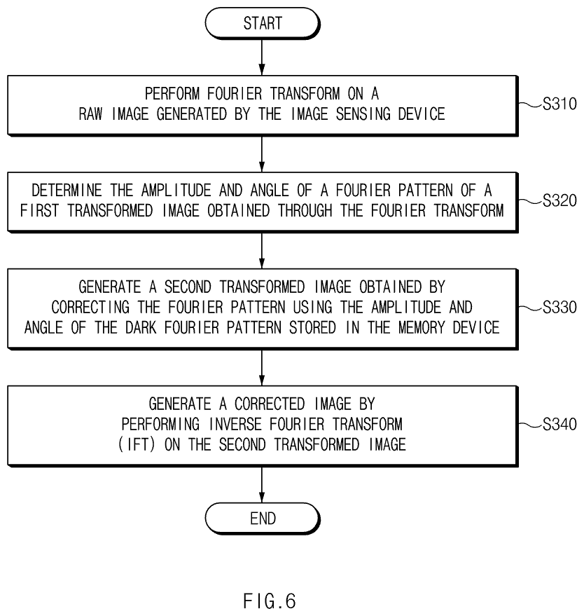

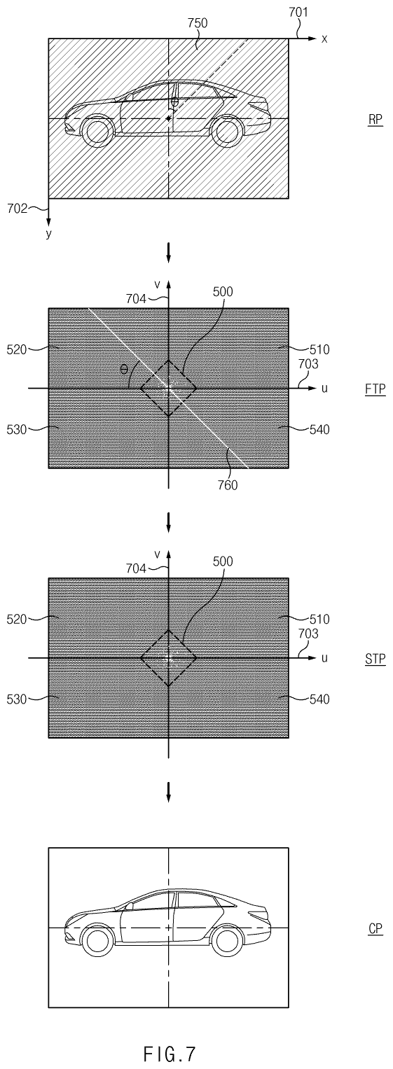

Each of coordinates in the transformed dark image (DTP) may be a coordinate value representing the progress direction, frequency, and amplitude of each wave function when the raw dark image (DRP) is expressed as the sum of wave functions. The central portion 400 located at a short distance from the origin in the transformed dark image (DTP) may correspond to the low-frequency region. Not only the Fourier-transformed transformed dark image (DTP), but also the transformed image (e.g., FTP in FIG. 7) to be described later with reference to FIG. 6 may have a relatively large amplitude in the low-frequency region, so the central portion 400 may have a relatively bright image (i.e., as the brightness of an image increases, the amplitude of the image increases).

While the regular defect pattern 450 of the raw dark image (DRP) has an angle ‘θ’ with respect to the Y-axis 402 indicating the vertical axis, the point P of the transformed dark image (DTP) has an angle ‘θ’ with respect to the X-axis 403 indicating the horizontal axis. This is because the proceeding direction of the wave function when the regular defect pattern 450 is expressed as waves is associated with the position of the point P and the wavefront of the waves and the proceeding direction of the waves are perpendicular to each other.

The dark Fourier pattern 460 may include the point (P). Since the transformed dark image (DTP) is an origin-symmetric image, the transformed dark image (DTP) may include the point (P) and another point (P′) that is symmetrical to the point (P) with respect to the origin. When the sizes of pixel values of pixels forming the regular defect pattern 450 are not constant, the regular defect pattern 450 may be expressed as the sum of a plurality of wave functions having different frequencies. In this case, the dark Fourier pattern 460 may include other points excluding the point (P) and the point (P′), and the other points may be located on a straight line passing through the points (P, P′).

In some implementations, when the proceeding direction of the regular defect pattern 450 slightly changes, the dark Fourier pattern 460 may include points located at the remaining parts other than the straight line passing through the points (P, P′). Since the proceeding direction of the regular defect pattern 450 caused by defects in the process of manufacturing the image sensing device 10 is not significantly changed within a predetermined range, the dark Fourier pattern 460 may have the shape of a set of points arranged in a direction on the Fourier pattern 460 corresponding to the specific direction.

The Fourier transform analysis unit 420 may determine whether the dark Fourier pattern 460 exists in the transformed dark image (DTP) (S230). The Fourier transform analysis unit 420 may determine a representative amplitude for each of the first to fourth quadrants (410, 420, 430, 440). The representative amplitude may be, for example, any one of an average value or a median value of the amplitudes included in each quadrant. The Fourier transform analysis unit 420 may compare the representative amplitude with a maximum amplitude for each quadrant. For example, the maximum amplitude of the coordinates included in the second quadrant 420 may be compared with the representative amplitude of the second quadrant 420. When a difference between the maximum amplitude and the representative amplitude is outside a predetermined error range (e.g., a preset range in which the maximum amplitude is K times the representative amplitude, where K is a real number of 2 or greater), the Fourier transform analysis unit 420 may determine the presence of the Fourier pattern.

In the above-described error range, in an embodiment in which the representative amplitude is the average amplitude, when the Fourier pattern does not exist, the maximum amplitude value may be 600 times the representative amplitude value or less. When the Fourier pattern exists, the maximum amplitude value may be, for example, 900 times the representative amplitude value or more.

The maximum amplitude value when the Fourier pattern exists may be 1.5 times or more than the maximum amplitude value when the Fourier pattern does not exist, and the representative amplitude value when the Fourier pattern exists may be 1.5 times or more than the representative amplitude value when the Fourier pattern does not exist.

The maximum amplitude when the Fourier pattern exists may be 5 times or more than the maximum amplitude when the Fourier pattern does not exist.

The above-described numerical values are disclosed only for illustrative purposes, and the disclosed technology is not limited thereto.

When there is a quadrant with the maximum amplitude located outside the error range from the representative amplitude of the quadrant, the Fourier transform analysis unit 420 may determine the presence of the dark Fourier pattern 460, and may determine at least one correction parameter by referring to the dark Fourier pattern 460 (S240). For example, as shown in FIG. 4, while the maximum amplitude of the first quadrant 410 falls within the error range compared to the representative amplitude of the first quadrant 410 and the maximum amplitude of the third quadrant 430 falls within the error range compared to the representative amplitude of the third quadrant 430 so that the dark Fourier pattern 460 is not formed in the first and third quadrants (410, 430), the maximum amplitude of the second quadrant 420 falls outside the error range compared to the representative amplitude of the second quadrant 420 and the maximum amplitude of the fourth quadrant 440 falls outside the error range compared to the representative amplitude of the fourth quadrant 440 so that the dark Fourier pattern 460 is formed in the second and fourth quadrants (420, 440). In this case, the Fourier transform analysis unit 420 may determine an angle (hereinafter referred to as “correction angle”) at which the point P or P′ having the above maximum amplitude is rotated clockwise from the u-axis 403. The correction parameter may include the correction angle. The Fourier transform analysis unit 420 may determine the amplitude of the point P (hereinafter referred to as “correction amplitude”). The correction parameter may include the correction amplitude. In some implementations, the correction parameter may further include the frequency indicated by the point P. In some other implementations, the correction parameter may include the entire transformed dark image (DTP).

The memory device 20 may store the correction angle and the correction amplitude determined by the Fourier transform analysis unit 420 as correction parameters (S250). In some implementations, the memory device 20 may further store the frequency as a correction parameter. In some implementations, the memory device 20 may store the transformed dark image (DTP) as a correction parameter. The correction parameters stored in the memory device 20 may be used in the process of allowing the image processing device 30 to correct the image generated by the image sensing device 10 during operation of the imaging device 1.

FIG. 5 is a block diagram illustrating an example of an image processing device 30 that can be included in the imaging device shown in FIG. 1 based on some implementations of the disclosed technology.

Referring to FIGS. 1 and 5, the image processing device 30 may correct the image (or raw image) generated by the image sensing device 10 when the imaging device 1 operates. The image processing device 30 may correct the raw image using the correction method based on the Fourier transform described above with reference to FIGS. 2 to 4. When the regular defect pattern exists in the raw image, the image processing device 30 may perform correction to remove the regular defect pattern. The image processing device 30 may include a Fourier transform operation unit 310, a Fourier transform image correction unit 330, and an inverse Fourier transform operation unit 340.

The Fourier transform operation unit 310 may perform Fourier transform on the raw image generated by the image sensing device 10 to generate a first transformed image. The first transformed image may be an origin-symmetric image obtained when the center of the first transformed image is set to the origin due to the above-described Fourier transform characteristics.

The Fourier transform image correction unit 330 may correct the first transformed image generated by the Fourier transform operation unit 310 using the correction parameters. For example, the Fourier transform image correction unit 330 may correct the first transformed image by removing or reducing certain image effect such as noise from the first transformed image. The correction parameters may be correction parameters stored in the memory device 20. When the Fourier transform image correction unit 330 corrects the first transformed image, a second transformed image may be generated. A method for correcting the first transformed image by the Fourier transform image correction unit 330 will be described later with reference to FIGS. 6 and 7.

The inverse Fourier transform operation unit 340 may perform inverse Fourier transform on the second transformed image. When the inverse Fourier transform operation unit 340 performs the inverse Fourier transform, a corrected image may be generated.

In some implementations, the image processing device 30 may further include a Fourier transform analysis unit (not shown). When the image processing device 30 further includes the Fourier transform analysis unit, the image testing method may include determining whether the regular defect pattern exists in the raw dark image output from the image sensing device 10 in a dark condition (e.g., in low light or complete darkness) using the Fourier transform analysis unit of the image processing device 30 without using the image test device 40 of FIG. 2. In FIG. 5, an embodiment in which the Fourier transform analysis unit is not separately included in the image processing device 30 is illustrated as an example.

In some other implementations, the image processing device 30 may further include a Fourier transform analysis unit (not shown). The Fourier transform analysis unit may further include substantially the same configuration as the Fourier transform analysis unit of FIG. 2. In this case, the process of determining the correction parameters may also be performed by the image processing device 30 rather than by the image test device 40. The disclosed technology can be implemented in some embodiments to provide the image processing device 30 that does not include the Fourier transform analysis unit.

FIG. 6 is a flowchart illustrating an example method of performing an image correction process by using the image processing device 30 shown in FIG. 5 based on some implementations of the disclosed technology.

FIG. 7 is a diagram illustrating an example of a method for correcting a raw image having a regular defect pattern 750 using the Fourier transform by the image processing device 30 shown in FIG. 5 based on some implementations of the disclosed technology.

In particular, as can be seen from the flowchart of FIG. 6, when a regular defect pattern exists in the raw image generated by the image sensing device 10, the image processing device 30 can generate a corrected image by removing the regular defect pattern from the raw image using the Fourier transform. In order to prevent duplication of explanation, a detailed description of the principle of Fourier transform explained with reference to FIGS. 4 and 5 will herein be omitted for brevity.

Referring to FIGS. 1 and 5 to 7, the Fourier transform operation unit 310 may perform Fourier transform on the raw image (RP) generated by the image sensing device 10 (S310). The raw image (RP) may refer to an image generated by capturing an external scene when the image sensing device 10 operates. The disclosed technology provides an example implementation in which the raw image (RP) includes the regular defect pattern 750. The raw image (RP) may include coordinates defined not only by the X-axis 701 that passes through the origin and extends horizontally, but also by the Y-axis 702 that passes through the origin and extends vertically. Each of the coordinates may have a pixel value corresponding to each pixel included in the pixel array of the image sensing device 100. The raw image (RP) may include signals defined within a (W×H) resolution range (where “W” and “H” are each integers equal to or greater than 1). When the Fourier transform operation unit 310 performs Fourier transform on the raw image (RP), the first transformed image (FTP) may be generated.

When the raw image (RP) is expressed as a function g (x, y), the first transformed image (FTP) generated by performing the Fourier transform can be expressed as a function G1(u, v) as represented by the following equation 2 (where “u” is any one of integers ranging from 0 to W-1, and “v” is any one of integers ranging from 0 to H-1). In FIG. 7, the image corresponding to log (|G1(u-W/2, v-H/2)|) is exemplarily illustrated as the first transformed image (FTP).

The Fourier transform image correction unit 330 may determine the amplitude and angle of the Fourier pattern 760 of the first transformed image (FTP) obtained through the Fourier transform process (S320). In an embodiment in which the image processing device 30 includes the Fourier transform analysis unit, operation S320 may be performed by the Fourier transform analysis unit. The disclosed technology can be implemented in another embodiment to provide the Fourier transform image correction unit 330 performs operation S320.

$${G}_{1} ( u , v ) = \frac{1}{WH} {\sum }_{x = 0}^{W - 1} {\sum }_{y = 0}^{H - 1} g ( x , y ) {e}^{- i 2 π ( u \frac{x}{W} + v \frac{y}{H} )} \qquad [ Equation 2 ]$$

The first transformed image (FTP) may be expressed as a function such as “G1(u, v)” as represented by Equation 2. The first transformed image (FTP) may include a Fourier pattern 760. When the raw image (RP) includes a regular defect pattern 750, the first transformed image (FTP) may have a Fourier pattern 760. The first transformed image (FTP) may be divided into first to fourth quadrants (510, 520, 530, 540) by the u-axis 703 and the v-axis 704.

The central portion 500 of the first transformed image (FTP) may be a low-frequency region with a relatively greater amplitude than the remaining regions other than the central portion 500. In some embodiments of the disclosed technology, the Fourier pattern 760 is formed in a shape of a set of points arranged in a specific direction (i.e., a direction in which the Fourier pattern 760 is rotated clockwise by a preset angle “θ” from the u-axis).

The Fourier transform image correction unit 330 may determine the Fourier pattern 760 that requires correction based on (1) the angle at which the Fourier pattern 760 of the first transformed image (FTP) is rotated clockwise from the u-axis; and (2) the amplitude of coordinates included in the Fourier pattern 760.

With respect to the u-axis 703 corresponding to a horizontal axis passing through the center of the first transformed image (FTP) and the v-axis 704 corresponding to a vertical axis passing through the center of the first transformed image (FTP), each of coordinates included in the first transformed image (FTP) may represent the proceeding direction of the wave function, the frequency of the wave function, and the amplitude of the wave function.

The Fourier transform image correction unit 330 may generate a second transformed image (STP) obtained by correcting the first transformed image (FTP) using correction parameters (e.g., the correction amplitude and the correction angle of the dark Fourier pattern) stored in the memory device 20 (S330). Some examples of a method for correcting the first transformed image (FTP) using the correction parameters by the Fourier transform image correction unit 330 will hereinafter be described with reference to the attached drawings.

The Fourier transform image correction unit 330 of the image processing device 30 based on an embodiment of the disclosed technology may subtract, from the transformed image (FTP), the correction amplitude of the dark Fourier pattern with respect to coordinates located on a straight line that is rotated by the correction angle from the horizontal axis of the second FFT image, resulting in formation of the second transformed image (STP). As another example, the Fourier transform image correction unit 330 of the image processing device 30 based on an embodiment of the disclosed technology may subtract the entire transformed dark image (DTP) including the dark Fourier pattern (e.g., 460 in FIG. 4) from the entire first transform image (FTP).

The Fourier transform image correction unit 330 of the image processing device 30 based on another embodiment of the disclosed technology may determine a quadrant through which a straight line rotated by a correction angle of the dark Fourier pattern (e.g., 460 in FIG. 4) from the u-axis 703 of the first transformed image (FTP) passes, to be a region that requires correction. For example, when the straight line that is rotated clockwise by the correction angle ‘θ’ from the u-axis 703 passes through the second quadrant 520 and the fourth quadrant 540, the Fourier transform image correction unit 330 may determine the second quadrant 520 and the fourth quadrant 540 of the first transformed image (FTP) to be regions that require correction. The Fourier transform image correction unit 330 may replace the coordinate values of the second quadrant 520 with the coordinate values of the first quadrant 510, and may replace the coordinate values of the fourth quadrant 540 with the coordinate values of the third quadrant 530. In some implementations, when the coordinate values are “replaced” with other coordinate values, each of coordinates included in the second quadrant 520 is replaced with the amplitude of the coordinates of the first quadrant 510 that is line-symmetrical with respect to the v-axis 740. In some other implementations, when the coordinate values are “replaced” with other coordinate values, each of coordinates included in the second quadrant 520 is replaced with the amplitude of coordinates of the third quadrant 530 that is line-symmetrical with respect to the u-axis 730. When coordinates (amplitudes) contained in a region (e.g., the second quadrant 520 and the fourth quadrant 540) to be corrected by the Fourier transform image correction unit 330 are replaced with coordinates that are line-symmetrical with respect to the u-axis 703 or the v-axis 704 of the adjacent quadrant, the second transformed image (STP) can be created.

The Fourier transform image correction unit 330 of the image processing device 30 based on another embodiment of the disclosed technology may determine (or reset) values of coordinates located at the straight line that is rotated by the correction angle “θ” of the dark Fourier pattern 460 from the u-axis 703 of the first transformed image (FTP) to be zero “0”, resulting in formation of the second transformed image (STP).

The second transformed image (STP) generated when the Fourier transform image correction unit 330 performs image correction based on the embodiments discussed above may be an image obtained when the Fourier pattern 460 is removed from the first transformed image (FTP).

The Fourier transform operation unit 310 may perform inverse Fourier transform (IFT) on the second transformed image (STP) (S340). When the Fourier transform operation unit 310 performs the inverse Fourier transform (IFT) on the second transformed image (STP), a corrected image (CP) may be generated. The corrected image may be an image from which the regular defect patterns 750 of the raw image have been removed. When the image processing procedure for correcting lens shading, etc. is required, the image processing device 30 may further perform specific processing required for shading correction on the corrected image, resulting in formation of a final image. For example, for lens shading correction, a signal corresponding to a pixel array portion having an insufficient amount of incident light may be set to have a greater gain, so that the final image can be output. In some other implementations, after lens shading correction is performed first, operations S310 to S340 may also be sequentially performed.

As is apparent from the above description, the imaging device based on some implementations of the disclosed technology may output a corrected image in which regular image defects have been corrected using the Fourier transform method.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image processing method comprising:
generating a first transformed image by performing Fourier transform on a raw image;
generating a second transformed image obtained by correcting an image effect present in the first transformed image using a correction parameter; and
generating a corrected image by performing inverse Fourier transform on the second transformed image.

2. The image processing method according to claim 1, wherein the correction parameter includes:
a transformed dark image obtained by performing Fourier transform on a raw dark image generated in a dark condition.

3. The image processing method according to claim 2, wherein:
the second transformed image is obtained by calculating a difference between the first transformed image and the transformed dark image.

4. The image processing method according to claim 1, wherein:
the correction parameter includes at least one of a correction angle and a correction amplitude.

5. The image processing method according to claim 4, wherein:
the correction amplitude is a largest amplitude among amplitudes of coordinates contained in a dark Fourier pattern included in a transformed dark image generated by performing Fourier transform on a raw dark image generated in a dark condition.

6. The image processing method according to claim 4, wherein:
the correction angle is an angle of rotation at which a dark Fourier pattern included in a transformed dark image generated by performing Fourier transform on a raw dark image generated in a dark condition is rotated clockwise from any one of a horizontal axis and a vertical axis by which the transformed dark image is divided into first, second, third, and fourth quadrants.

7. The image processing method according to claim 6, wherein:
the first transformed image includes a Fourier pattern that includes a set of points located along a straight line rotated clockwise from the horizontal axis or the vertical axis by the correction angle; and
the second transformed image is an image in which wave amplitudes of coordinates of the first transformed image contained in a quadrant including the dark Fourier pattern are respectively replaced with wave amplitudes of other coordinates symmetrical to any one of the horizontal axis and the vertical axis.

8. The image processing method according to claim 5, wherein:
the first transformed image includes a Fourier pattern that includes a set of points located along a straight line rotated clockwise from a horizontal axis or a vertical axis by the correction angle; and
the second transformed image is an image in which the amplitude of each of coordinates on the Fourier pattern is set to zero.

9. An imaging device comprising:
a Fourier transform operation unit configured to generate a first transformed image by performing Fourier transform on a raw image;
a Fourier transform image correction unit configured to generate a second transformed image obtained by correcting the first transformed image using a correction parameter corresponding to the first transformed image; and
an inverse Fourier transform operation unit configured to generate a corrected image by performing inverse Fourier transform on the second transformed image.

10. The imaging device according to claim 9, wherein the correction parameter includes:
a transformed dark image obtained by performing Fourier transform on a raw dark image generated in a dark condition.

11. The imaging device according to claim 9, further comprising:
a memory device configured to store a transformed dark image obtained by performing Fourier transform on a raw dark image generated in a dark condition.

12. The imaging device according to claim 9, wherein:
the second transformed image is obtained by calculating a difference between the first transformed image and a transformed dark image obtained by performing Fourier transform on a raw dark image generated in a dark condition.

13. The imaging device according to claim 9, wherein:
the correction parameter includes at least one of a correction angle and a correction amplitude.

14. The imaging device according to claim 13, further comprising:
a memory device configured to store the correction parameter.

15. The imaging device according to claim 13, wherein:
the correction amplitude is a largest amplitude among amplitudes of coordinates contained in a dark Fourier pattern included in a transformed dark image generated by performing Fourier transform on a raw dark image generated in a dark condition.

16. The imaging device according to claim 13, wherein:
the correction angle is an angle of rotation at which a dark Fourier pattern included in a transformed dark image generated by performing Fourier transform on a raw dark image generated in a dark condition is rotated clockwise from any one of a horizontal axis and a vertical axis by which the transformed dark image is divided into first, second, third, and fourth quadrants.

17. The imaging device according to claim 16, wherein:
the first transformed image includes a Fourier pattern that includes a set of points located along a straight line rotated clockwise from the horizontal axis or the vertical axis by the correction angle; and
the second transformed image is an image in which wave amplitudes of coordinates of the first transformed image contained in a quadrant including the dark Fourier pattern are respectively replaced with wave amplitudes of other coordinates symmetrical to any one of the horizontal axis and the vertical axis.

18. The imaging device according to claim 16, wherein:
the first transformed image includes a Fourier pattern that includes a set of points located along a straight line rotated clockwise from the horizontal axis or the vertical axis by the correction angle; and
the second transformed image is an image in which the amplitude of each of coordinates on the Fourier pattern is set to zero.

19. An image testing method comprising:
outputting a raw dark image from an image sensing device in a dark condition;
generating a transformed dark image by performing Fourier transform on the raw dark image;
dividing the transformed dark image into first to fourth quadrants, and comparing an average amplitude value or a median amplitude value of amplitude values of coordinates of the first to fourth quadrants with a maximum amplitude value among the amplitude values of the coordinates of the first to fourth quadrants; and
determining a correction angle and a correction amplitude of a dark Fourier pattern contained in the transformed dark image according to a result of the comparison.

20. The image testing method according to claim 19, wherein:
the dark Fourier pattern includes a set of points located along a straight line; and
the correction angle is an angle of rotation at which the straight line is rotated clockwise from any one of a horizontal axis and a vertical axis by which the transformed dark image is divided into first, second, third, and fourth quadrants.

21. The image testing method according to claim 20, wherein:
the correction amplitude is a maximum amplitude value among amplitudes of points contained in the dark Fourier pattern.

22. The image testing method according to claim 19, further comprising:
when comparing the maximum amplitude value from among the amplitude values of the coordinates of each of the first to fourth quadrants with the average amplitude value of the amplitude values of the coordinates of the first to fourth quadrants, in response to a determination that the maximum amplitude value is 900 times the average amplitude value or more, determining that the dark Fourier pattern is present.
